(19) United States
(12) Patent Application Publication
(10) Pub. No.: US 2015/0332342 A1
(43) Pub. Date: Nov. 19, 2015

(54) SYSTEM AND METHOD FOR PROVIDING CONTENT ITEMS TO USERS RESPECTIVE OF PRODUCTS OR SERVICES

(71) Applicant: CORTICA, LTD., TEL AVIV (IL)

(72) Inventors: Igal Raichelgauz, New York, NY (US); Karina Odinaev, New York, NY (US); Yehoshua Y. Zeevi, Haifa (IL)

(73) Assignee: CORTICA, LTD., TEL AVIV (IL)

(21) Appl. No.: 14/811,201

(22) Filed: Jul. 28, 2015

Related U.S. Application Data
(63) Continuation-in-part of application No. 14/643,694, filed on Mar. 10, 2015.
Application No. 14/643,694 is a continuation of application No. 13/766,463, filed on Feb. 13, 2013, now Pat. No. 9,031,999.
Application No. 13/766,463 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/030,076, filed on Jul. 29, 2014.

(30) Foreign Application Priority Data
Oct. 26, 2005 (IL) 171577
Jan. 29, 2006 (IL) 173409
Aug. 21, 2007 (IL) 185414

(51) Int. Cl. G06Q 30/02

(52) U.S. Cl. CPC G06Q 30/0269

(57) ABSTRACT

A method and system for searching for content items of an interest to a user are provided. The method includes receiving a request including at least one multimedia content element from a user device associated with the user; identifying at least one identifier related to the user device; generating at least one signature for the at least one multimedia content element; searching for at least one concept matching the at least one generated signature; searching for content items based on the at least one matching concept and the at least one identifier, wherein each content item found through the search is related to at least a product of interest to the user; and providing the content items to the user device.

### CROSS-REFERENCE TO RELATED APPLICATIONS

This application claims the benefit of U.S. provisional application No. 62/030,076 filed on Jul. 29, 2014. This application is also a continuation-in-part (CIP) of U.S. patent application Ser. No. 14/643,694, filed on Mar. 10, 2015, now pending. The Ser. No. 14/643,694 application is a continuation of U.S. patent application Ser. No. 13/766,463 filed on Feb. 13, 2013, now allowed. The Ser. No. 13/766,463 Application is a continuation-in-part of U.S. patent application Ser. No. 13/602,858 filed on Sep. 4, 2012, now U.S. Pat. No. 8,868,619. The Ser. No. 13/602,858 Application is a continuation of U.S. patent application Ser. No. 12/603,123 filed on Oct. 21, 2009, now U.S. Pat. No. 8,266,185. The Ser. No. 12/603,123 Application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005 and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;

(3) U.S. patent application Ser. No. 12/348,888 filed on Jan. 5, 2009, now pending, which is a continuation-in-part of the above-referenced U.S. patent application Ser. No. 12/084,150 and the above-referenced U.S. patent application Ser. No. 12/195,863; and

(4) U.S. patent application Ser. No. 12/538,495 filed on Aug. 10, 2009, now U.S. Pat. No. 8,312,031, which is a continuation-in-part of the above-referenced U.S. patent application Ser. No. 12/084,150, the above-referenced U.S. patent application Ser. No. 12/195,863, and the above-referenced U.S. patent application Ser. No. 12/348,888.

The contents of all of the applications referenced above are herein incorporated by reference.

### TECHNICAL FIELD

The present disclosure relates generally to the analysis of multimedia content elements, and more specifically for providing customized content items to user devices respective of multimedia content elements captured by the user devices.

### BACKGROUND

Retailers and publishers are always interested in increasing engagement with their clients. One way to increase a client's engagement is to gauge the client's interest based on the client's need and address the interest.

Gauging a buyer's interest may be valuable, for example, in making a sale. For example, it may be advantageous to offer certain buyers (or users) a discount upon detection that the buyer (user) is interested in a certain product but cannot afford the price.

Managers of retail stores would like to gauge buyers' interest in certain products in real-time while they stroll through the store in order to offer discounts and sales. However, due to the sizes of retail stores today and the amount of buyers who stroll in such stores during most of the day, it is quite a difficult task to identify a buyer's need in real-time. Furthermore, it is difficult to adjust prices in real-time in a retail store before a customer leaves the store.

It would therefore be advantageous to overcome the limitations of the prior art by providing a solution to enable retailers to increase engagement of users.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments include a method for searching for content items of an interest to a user. The method comprises: receiving a request including at least one multimedia content element from a user device associated with the user; identifying at least one identifier related to the user device; generating at least one signature for the at least one multimedia content element; searching for at least one concept matching the at least one generated signature; searching for content items based on the at least one matching concept and the at least one identifier, wherein each content item found through the search is related to at least a product of interest to the user; and providing the content items to the user device.

Certain embodiments include a system for providing content to users respective of multimedia content elements. The system comprises: a processor; and a memory coupled to the processor, the memory contains instructions that when executed by the processor cause the system to: receive a request including at least one multimedia content element from a user device associated with the user; identify at least one identifier related to the user device; generate at least one signature for the at least one multimedia content element; search for at least one concept matching the at least one generated signature; search for content items based on the at least one matching concept and the at least one identifier, wherein each content item found through the search is related to at least a product of interest to the user; and provide the content items to the user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a networked system utilized to describe the various disclosed embodiments.

FIG. 2 is a flowchart describing a method for searching for content items that may be of an interest to the user according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

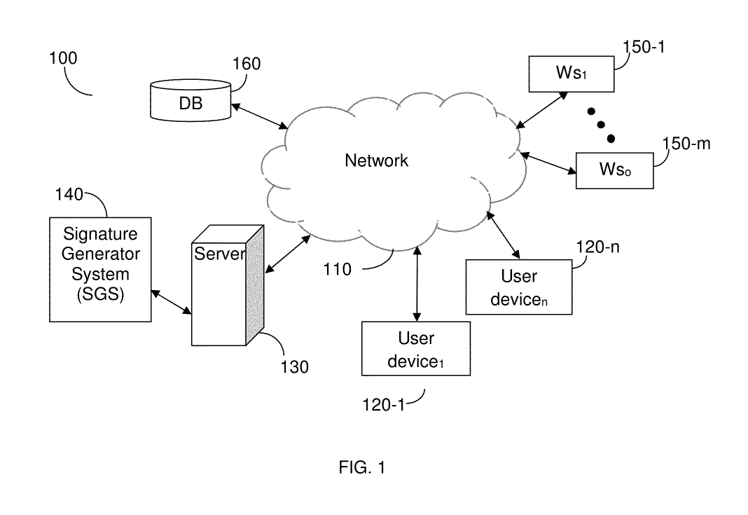

FIG. 1 shows an exemplary and non-limiting schematic diagram of a networked system 100 utilized to describe the various embodiments herein. A network 110 is used to communicate between different parts of the system 100. The network 110 may be the Internet, the world-wide-web (WWW), a local area network (LAN), a wide area network (WAN), a metro area network (MAN), and other networks for enabling communication between the elements of the system 100. Further connected to the network 110 are one or more user devices (UD) 120-1 through 120-n (collectively referred to hereinafter as user devices 120 or individually as a user device 120, merely for simplicity purposes). A user device 120 may be, for example, a mobile phone, a smart phone, a tablet computer, a wearable computing device, a personal computer, and other kinds of wired and mobile appliances equipped with browsing, viewing, listening, capturing, and managing capabilities, etc., that are enabled as further discussed herein below.

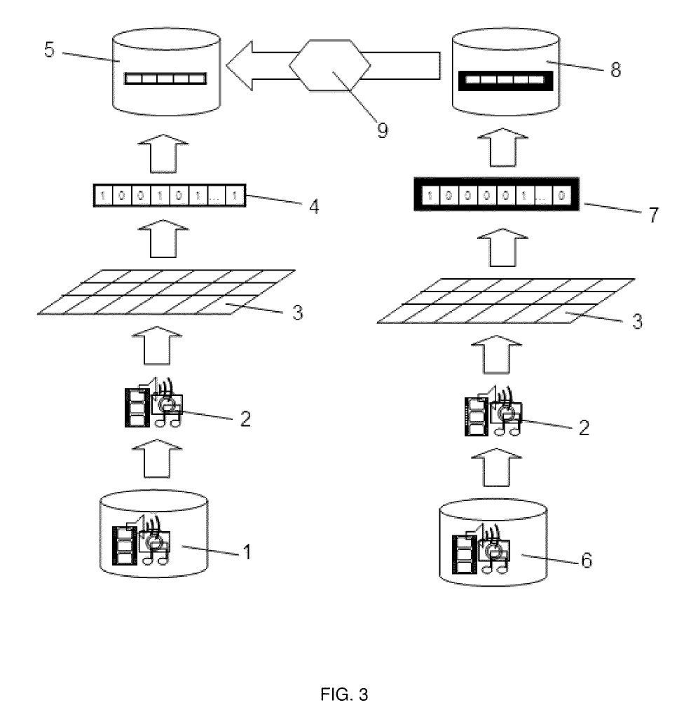

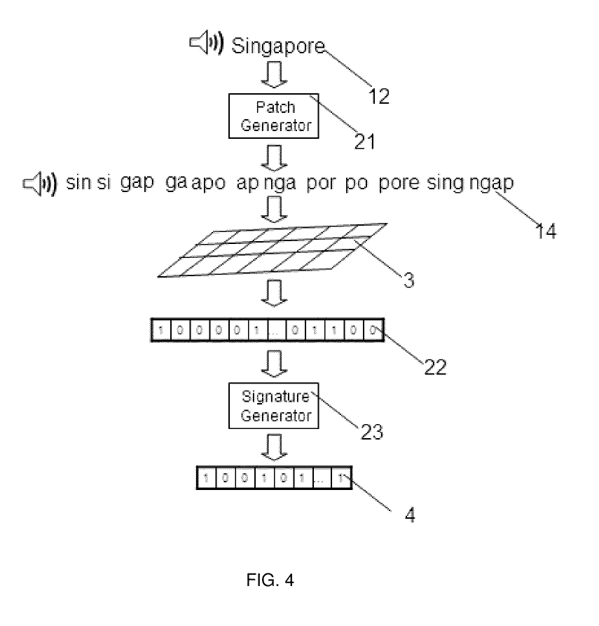

A server 130 is further connected to the network 110. The networked system 100 also includes a signature generator system (SGS) 140. In one embodiment, the SGS 140 is communicatively connected to the server 130 either directly or through the network 110. In another embodiment, the SGS 140 is a component integrated in, or added as an add-on to, the server 130. The server 130 is configured to receive and serve multimedia content elements and causes the SGS 140 to generate a signature for each of a plurality of multimedia content elements. The process for generating the signatures for multimedia content elements is explained in more detail herein below with respect to FIGS. 3 and 4.

A plurality of web servers 150-1 through 150-m (collectively referred to hereinafter as web servers 150 or individually as a web server 150, merely for simplicity purposes) are also connected to the network 110. The web servers 150 contain data that can be associated with user devices 120 by the server 130 as further described herein below. The web server 150 may be, for example, retailers' servers, publishers' servers, loyalty clubs' servers, and the like.

According to the disclosed embodiments, the server 130 is configured to receive at least one multimedia content element from the user device 120. According to one embodiment, at least one good and/or service (collectively referred hereinafter as “products” or “product”) is displayed, mentioned or included in the multimedia content element. The server 130 is further configured to identify at least one identifier related to the user device 120-1. The identifier may be, for example, a phone number associated with the user device 120-1, a type of the user device 120-1, metadata related to a user of the user device 120-1, location of the user device 120-1, a time that the multimedia content element is received, and so on.

According to one embodiment, the identifier is received by the server 130 as an input from the user device 120. In an embodiment, the identifier may extracted from a request (e.g., HTTP request) sent by the device 120. Typically, such a request would also include the multimedia content element. Then, the server 130 using the SGS 140 is configured to generate at least one signature for the received multimedia content element. Finally, using the generated signature(s), at least one matching concept is identified and retrieved. In an embodiment, the at least one matching concept is retrieved from a concepts database 160.

A concept is a collection of signatures representing elements of the unstructured data and metadata describing the concept. Each concept is represented by one or more signature reduced clusters (SRCs). As a non-limiting example, a ‘Superman concept’ is a signature reduced cluster (SRC) of signatures describing elements (such as multimedia content elements) related to, e.g., a Superman cartoon: a set of metadata representing textual representation of the Superman concept. Techniques for generating concepts and concept structures are also described in U.S. Pat. No. 8,266,185 to Raichelgauz, et al., which is assigned to common assignee, and is incorporated hereby by reference for all that it contains.

An exemplary database of concepts (e.g., the database 160) is disclosed in U.S. Pat. No. 9,031,999, filed Feb. 13, 2013 to Raichelguaz, et al., also assigned to common assignee, and is hereby incorporated by reference for all the useful information it contains.

According to the embodiment given above, the server 130 is then configured to search through the web servers 150 for one or more product-related content items that may be of interest to a user of the user device 120. Such content items are typically related to an advertised or non-advertised product or service. For example, such a content item may be any type of multimedia content element as described hereinabove that includes, for example: a price modification of a product, terms associated with purchasing a product, description of the product and so on. The content item may include a link to a website hosted by one of the web servers 150.

The interest of the user in the content item is determined based on the at least one identifier of the user device 120. The server 130 is configured to provide the content items to the user device 120. As an example, if an identifier indicates the user device is in a Macy's® retail store, the server 130 will return content items containing price information of products sold in Macy's®. The content items will include links (call-to-actions) directing the user, for example, to a website of Macy's® hosted by one of the web servers 150.

As another example, for the operation of the disclosed embodiments, the server 130 is configured to receive an image captured by a user device 120 over the network 110. A phone number associated with the user device 120 is further received by the server 130. In addition, the location of the user device 120 in a certain retail store is further identified by the server 130. The image is then analyzed by the server 130 and a signature is generated respective thereto. A concept associated with the generated signature enables identification by the server 130 that the image is of a milk carton of a certain brand in a certain size. The matching concept may be “milk products”. The server 130 then checks with a web server 150 associated with the retailer store in which the user device 120 is identified the price for the milk carton requested from the user device 120. The price is then sent by the server 130 for display on the user device 120.

In some configurations, the server 130 and the SGS 140 comprise a processing unit, such as a processor that is coupled to a memory. The processing unit may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may be coupled to the memory. In an embodiment, the memory contains instructions that when executed by the processing unit results in the performance of the methods and processes described herein below. Specifically, the processing unit may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit to perform the various functions described herein. In some configurations, the processing unit may include an array of computational cored configured as discussed in detail below.

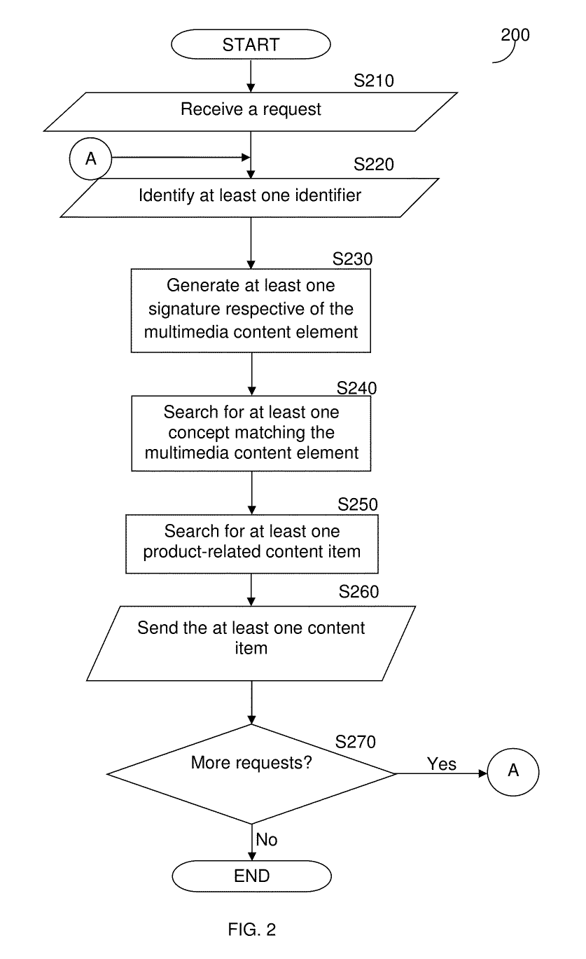

FIG. 2 is an exemplary and non-limiting flowchart 200 describing a method for searching for content items that may be of an interest to the user according to an embodiment. The method may be performed by the server 130. Without limiting the scope of the disclosed embodiment, the method will be discussed with reference to the various elements shown in FIG. 1. The content items are related to products that can be purchased or utilized by the user of the user device 120.

In S210, a request is received from a user device 120. The request includes a multimedia content element (or portions thereof) in which a product is included. The request is for searching for content items matching or related to the multimedia content element. The received multimedia content element may include, for example, an image, a graphic, a video stream, a video clip, an audio stream, an audio clip, a video frame, a photograph, and an image of signals, and/or combinations thereof and portions thereof.

In S220, at least one identifier respective of the user device 120 is identified. Various examples for such an identifier are provided above. In one embodiment, S220 includes analyzing the request to identify the identifier. For example, a source IP address of the user device 120 may indicate on the device's location. Collectively or alternatively, S220 may include querying the user device 120 or other external sources (not shown) for the identifiers.

In S230, at least one signature is generated respective of the received multimedia content element. The signature for the multimedia content element is generated by the SGS 140 as described below. As noted above, the generated signature may be robust to noise and distortions. A signature can be generated for each portion identified in the input multimedia content element.

In S240, at least one concept matching the received multimedia content element is searched for. In an embodiment, the search is performed in the concepts database 160. In this embodiment, the search for matching concepts is based on matching signatures. To this end, the signature generated for the received content element is compared to SRCs of the concepts maintained in the concepts database 160. Two signatures are considered matching if they overlap more than a predetermined threshold level, e.g., 50%. In one embodiment, only concepts related to products are searched. It should be noted that if no matching concept is found, execution terminates.

In S250, at least one product-related content item describing or depicting information of a product of interest to the user is searched for. In an embodiment, the interest of the user is determined based on the at least one device identifier. In an embodiment, S250 includes retrieving, from the concepts database 160, multimedia content elements associated with the matching concepts. Such elements are considered as the content items. In such an embodiment, the concepts database 160 includes indexes for mapping the multimedia content elements to their respective concepts. In another embodiment, S250 includes searching the web servers 150 for content items using the SRC of the matching concept. According to this embodiment, for each multimedia content encountered during the search at least one signature is generated by the SGS 140. If the signatures of the concept and of the multimedia content element match above a predetermined threshold, the multimedia content element is included in the search results. The search is performed by means of the server 130. In yet another embodiment, the search for content items through the web servers 150 may be performed using the metadata of the matching concept. For example, such a metadata serves a search (textual query).

In some embodiments, S250 includes determining, using the generated signatures, a context for the multimedia content element and/or the portions of a particular interest to determine the textual query. A context is a correlation of a plurality of concepts, thus the correlated metadata of the context (i.e., its concepts) can be utilized as the textual query. An exemplary technique for determining a context is described in detail in U.S. patent application Ser. No. 13/770,603, filed on 19 Feb., 2013, assigned to common assignee, which is hereby incorporated by reference for all the useful information it contains.

S250 further includes filtering the search results (either from the concepts database 160 or the web servers 150) based on the at least one identifier. This ensures that only search results of interest to the user are utilized. The search results are the content items. As an example, only content items of products sold by a certain store that the user is currently located in will be returned.

It should be appreciated that using signatures to search for multimedia content elements allows for the retrieval and reorganization of accurate results including, but not limited to, multimedia elements in comparison to utilization of metadata. The signatures generated by the SGS 140 for the concepts allow for recognition and classification of the found multimedia elements, such as, content-tracking, video filtering, multimedia taxonomy generation, video fingerprinting, speech-to-text, audio classification, element recognition, video/image search and any other application requiring content-based signatures generation and matching for large content volumes such as web and other large-scale databases. For example, a signature generated by the SGS 140 for a picture showing a car enables accurate recognition of the model of the car from any angle from which the picture was taken.

In S260, the at least one content item found is sent to the user device 120. The user device 120 can cause the display of such content items. In S270, it is checked whether additional requests need to be served, and if so, execution continues with S210; otherwise, execution terminates.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational cores 3 that constitute an architecture for generating the signatures (hereinafter the “Architecture”). Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., signatures that are robust to additive noise L (where L is an integer equal to or greater than 1) by the computational cores 3 a frame T is injected into all the cores 3. Then, the cores 3 generate two binary response vectors: \vec{S} which is a signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = Π ( Vi - {Th}_{x} )$$

where, [symbol] is a Heaviside step function; wᵢⱼ is a coupling node unit (CNU) between node i and image component j (for example, grayscale value of a certain pixel j); kⱼ is an image component T (for example, grayscale value of a certain pixel j); Thₓ is a constant threshold value, where x is ‘S’ for signature and ‘RS’ for Robust Signature; and Vi is a Coupling Node Value.

The threshold values Thₓ are set differently for signature generation and for Robust Signature generation. For example, for a certain distribution of Vi values (for the set of nodes), the thresholds for signature (Th_{S}) and Robust Signature (Th_{RS}) are set apart, after optimization, according to at least one or more of the following criteria:

For: Vᵢ>Th_{RS}

1−p(V>Th_{S})−1−(1−δ)^{l}<<1 1:

i.e., given that l nodes (cores) constitute a Robust Signature of a certain image I, the probability that not all of these I nodes will belong to the signature of same, but noisy image, Ĩ is sufficiently low (according to a system's specified accuracy).

p(Vᵢ>Th_{RS})≅l/L 2:

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation can be found in U.S. Pat. Nos. 8,326,775 and 8,312,031, assigned to common assignee, that are hereby incorporated by reference for all the useful information they contain.

A computational core generation is a process of definition, selection, and tuning of the parameters of the cores for a certain realization in a specific system and application. The process is based on several design considerations, such as:
(a) The cores should be designed so as to obtain maximal independence, i.e., the projection from a signal space should generate a maximal pair-wise distance between any two cores' projections into a high-dimensional space.
(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The cores should be optimally designed with regard to invariance to a set of signal distortions, of interest in relevant applications. A detailed description of the computational core generation and the process for configuring such cores is discussed in more detail in U.S. Pat. No. 8,655,801 referenced above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for searching for content items of an interest to a user, comprising:
receiving a request including at least one multimedia content element from a user device associated with the user;
identifying at least one identifier related to the user device;
generating at least one signature for the at least one multimedia content element;
searching for at least one concept matching the at least one generated signature;
searching for content items based on the at least one matching concept and the at least one identifier, wherein each content item found through the search is related to at least a product of interest to the user; and
providing the content items to the user device.

2. The method of claim 1, wherein a concept is a collection of signatures representing multimedia content elements of unstructured data and metadata describing the concept, wherein the concept is represented by at least one signature reduced cluster (SRC).

3. The method of claim 2, wherein the at least one concept is stored in a concepts database.

4. The method of claim 2, wherein identifying the at least one matching concept further comprises:
generating at least one signature for the received multimedia content element; and
comparing the at least one generated signature to SRCs of concepts stored in the concepts database, wherein a concept having a SRC that matches the at least one generated signature is determined to be a matching concept.

5. The method of claim 1, wherein searching for the content items further comprises:
retrieving a SRC for the at least one matching concept;
comparing the at least one signature to the SRC; and
searching through a plurality of web servers for the at least one multimedia content that matches the retrieved SRC.

6. The method of claim 5, wherein the at least one web server is any one of: a retailer server, a publisher server, and a loyalty club server.

7. The method of claim 2, wherein searching for content items further comprises:
generating at least one signature for each content item encountered during the search; and
comparing the SRC to the at least one signature for each content item, wherein each content item is considered related to the product of interest to the user if the SRC and the at least one signature for each content item match above a predetermined threshold.

8. The method of claim 2, wherein searching for the at least one multimedia content element further comprises:
retrieving the at least one multimedia content element associated with the matching concept, wherein the at least one retrieved multimedia content element is a content item.

9. The method of claim 2, wherein searching for the at least one multimedia content element further comprises:
retrieving at least a metadata of the matching concept; and
searching through a plurality of web server for the content items using the metadata.

10. The method of claim 1, further comprising:
filtering the content items based on the at least on identifier.

11. The method of claim 10, wherein the identifier is any one of: a phone number associated with the user device, a type of the user device, metadata related to a user of the user device, and a location of the user device.

12. The method of claim 1, wherein the content item includes product-related information.

13. The method of claim 1, wherein the at least one multimedia content element is at least one of: an image, graphics, a video stream, a video clip, an audio stream, an audio clip, a video frame, a photograph, images of signals, and portions thereof.

14. A non-transitory computer readable medium having stored thereon instructions for causing one or more processing units to execute the method according to claim 1.

15. A system for providing content to users respective of multimedia content elements, comprising:
a processor; and
a memory coupled to the processor, the memory contains instructions that when executed by the processor cause the system to:
receive a request including at least one multimedia content element from a user device associated with the user;
identify at least one identifier related to the user device;
generate at least one signature for the at least one multimedia content element;
search for at least one concept matching the at least one generated signature;
search for content items based on the at least one matching concept and the at least one identifier, wherein each content item found through the search is related to at least a product of interest to the user; and
provide the content items to the user device.

16. The system of claim 15, wherein a concept is a collection of signatures representing multimedia content elements of unstructured data and metadata describing the concept, wherein the concept is represented by at least one signature reduced cluster (SRC).

17. The system of claim 16, wherein the at least one concept is stored in a concepts database.

18. The system of claim 16, wherein the system is further configured to:
generate at least one signature for the received multimedia content element; and
compare the at least one generated signature to SRCs of concepts stored in the concepts database, wherein a concept having a SRC that matches the at least one generated signature is determined to be a matching concept.

19. The system of claim 15, wherein the system is further configured to:
retrieve a SRC for the at least one matching concept;
compare the at least one signature to the SRC; and
search through a plurality of web servers for the at least one multimedia content that matches the retrieved SRC.

20. The system of claim 19, wherein the at least one web server is any one of: a retailer server, a publisher server, and a loyalty club server.

21. The system of claim 15, wherein the system is further configured to:
generate at least one signature for each content item encountered during the search; and
compare the SRC to the at least one signature for each content item, wherein each content item is considered related to the product of interest to the user if the SRC and the at least one signature for each content item match above a predetermined threshold.

22. The system of claim 16, wherein the system is further configured to:
retrieve the at least one multimedia content element associated with the matching concept, wherein the at least one retrieved multimedia content element is a content item.

23. The system of claim 16, wherein the system is further configured to:
retrieve at least a metadata of the matching concept; and
search through a plurality of web server for the content items using the metadata.

24. The system of claim 15, wherein the system is further configured to:
filter the content items based on the at least on identifier.

25. The system of claim 24, wherein the identifier is any one of: a phone number associated with the user device, a type of the user device, metadata related to a user of the user device, and a location of the user device.

26. The system of claim 15, wherein the content item includes product-related information.

27. The system of claim 15, wherein the at least one multimedia content element is at least one of: an image, graphics, a video stream, a video clip, an audio stream, an audio clip, a video frame, a photograph, images of signals, and portions thereof.
